(19) United States
(12) Patent Application Publication
(10) Pub. No.: US 2024/0273605 A1
(43) Pub. Date: Aug. 15, 2024

(54) INFORMATION PROCESSING APPARATUS, INFORMATION PROCESSING METHOD, AND INFORMATION PROCESSING PROGRAM

(71) Applicant: ZOZO, Inc., Chiba (JP)

(72) Inventors: Takuya UEDA, Chiba (JP); Kengo ONO, Chiba (JP); Yasuhiro MORITA, Chiba (JP); Fuminori ANDO, Chiba (JP)

(21) Appl. No.: 18/566,073

(22) PCT Filed: Aug. 3, 2022
(86) PCT No.: PCT/IB2022/057194

§ 371 Date: Nov. 30, 2023

(30) Foreign Application Priority Data
Jun. 4, 2021 (JP) 2021-094803

(51) Int. Cl. G06Q 30/0601; G06Q 30/0201

(52) U.S. Cl. CPC G06Q 30/0631; G06Q 30/0201; G06Q 30/0627; G06Q 30/0643

(57) ABSTRACT

To promote improvement in services in accordance with a target body shape of a user. An information processing apparatus includes an acquisition unit, a calculation unit, and a providing unit. The acquisition unit acquires body shape information on a body shape of a user. The calculation unit calculates, based on comparison between the body shape information on the user acquired by the acquisition unit and statistical data of body shape information that is based on attribute information on the user, a difference from a standard body shape that is based on the statistical data. The providing unit that provides information on a target body shape as a goal to be achieved by the user in accordance with the difference that is calculated by the calculation unit.

### FIELD

The present invention relates to an information processing apparatus, an information processing method, and an information processing program.

### BACKGROUND

Conventionally, a technology for proposing a target object, such as clothes, to a user is known. For example, a technology for proposing a target object that fits a body shape of a user based on body information on the user is known.

### CITATION LIST

### Patent Literature

Japanese Laid-open Patent Publication No. 2020-144503

### SUMMARY

### Technical Problem

However, in the conventional technology, it is difficult to improve services in accordance with a target body shape of the user.

The present application has been conceived in view of the foregoing situation, and an object of the present application is to promote improvement in services in accordance with a target body shape of a user.

### Solution to Problem

According to the present disclosure, an information processing apparatus includes: an acquisition unit that acquires body shape information on a body shape of a user; calculation unit that calculates, based on comparison between the body shape information on the user acquired by the acquisition unit and statistical data of body shape information that is based on attribute information on the user, a difference from a standard body shape that is based on the statistical data; and a providing unit that provides information on a target body shape as a goal to be achieved by the user in accordance with the difference that is calculated by the calculation unit.

### Advantageous Effects of Invention

According to one aspect of embodiments, it is possible to promote improvement in services in accordance with a target body shape of a user.

### BRIEF DESCRIPTION OF DRAWINGS

FIG. 1 is a diagram illustrating a configuration example of an information processing system according to one embodiment.

FIG. 2 is a diagram illustrating an example of information processing according to one embodiment.

FIG. 3 is a diagram illustrating a configuration example of a terminal apparatus according to one embodiment.

FIG. 4 is a diagram illustrating a configuration example of an information processing apparatus according to one embodiment.

FIG. 5 is a diagram illustrating an example of a body shape information storage unit according to one embodiment.

FIG. 6 is a diagram illustrating an example of a purchase history storage unit according to one embodiment.

FIG. 7 is a diagram illustrating an example of a user information storage unit according to one embodiment.

FIG. 8 is a diagram illustrating a configuration example of a management server according to one embodiment.

FIG. 9 is a diagram illustrating an example of a clothes information storage unit according to one embodiment.

FIG. 10 is a flowchart illustrating an example of information processing according to one embodiment.

FIG. 11 is a diagram illustrating an example of information processing according to a modification.

FIG. 12 is a hardware configuration diagram illustrating an example of a computer that implements functions of the information processing apparatus.

### DESCRIPTION OF EMBODIMENTS

Modes (hereinafter, referred to as “embodiments”) for carrying out an information processing apparatus, an information processing method, and an information processing program according to the present application will be described in detail below with reference to the drawings. The information processing apparatus, the information processing method, and the information processing program according to the present application are not limited by the embodiments below. In addition, in each of the embodiments below, the same components are denoted by the same reference symbols, and repeated explanation will be omitted.

### EMBODIMENT

### 1. Configuration of Information Processing System

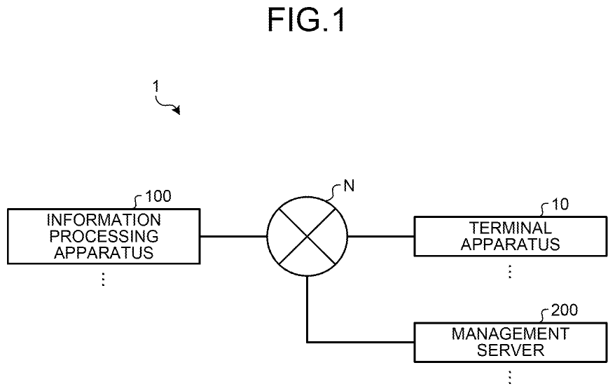

An information processing system 1 illustrated in FIG. 1 will be described. As illustrated in FIG. 1, the information processing system 1 includes a terminal apparatus 10, an information processing apparatus 100, and a management server 200. The terminal apparatus 10, the information processing apparatus 100, and the management server 200 are communicably connected to one another via a predetermined communication network (a network N) in a wired or wireless manner. FIG. 1 is a diagram illustrating a configuration example of the information processing system 1 according to one embodiment. Meanwhile, the information processing system 1 illustrated in FIG. 1 may include the plurality of terminal apparatuses 10, the plurality of information processing apparatuses 100, and the plurality of management servers 200.

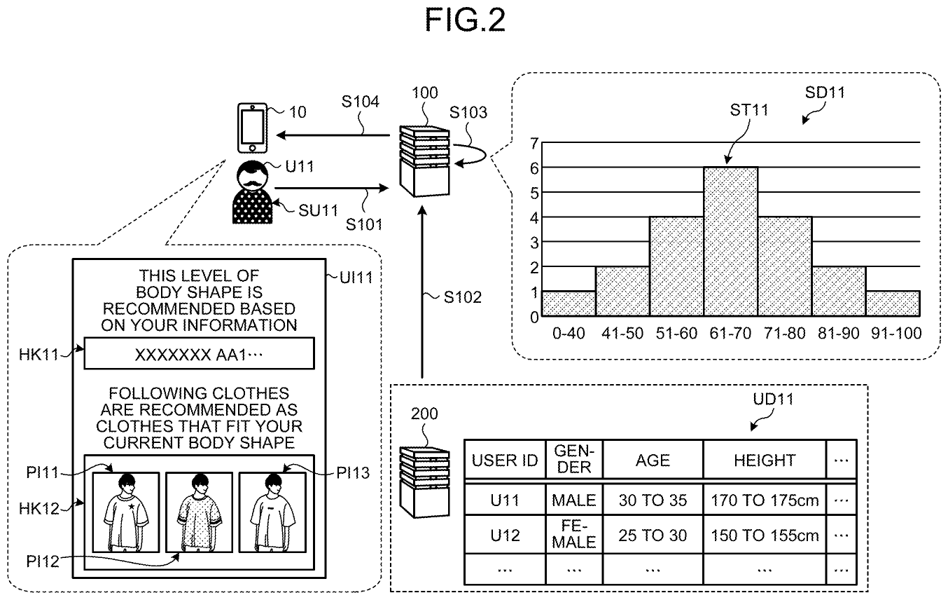

The terminal apparatus 10 is an information processing apparatus that is used by a user. The terminal apparatus 10 may be any apparatus as long as it is possible to implement processes of embodiments. Further, the terminal apparatus 10 may be any apparatus, such as a smartphone, a tablet terminal, a notebook personal computer (PC), a desktop PC, a mobile phone, or a portable digital assistant (PDA). In an example illustrated in FIG. 2, a case is illustrated in which the terminal apparatus 10 is a smartphone.

The terminal apparatus 10 is, for example, a smart device, such as a smartphone or a tablet, and is a mobile terminal apparatus that is able to perform communication with an arbitrary server apparatus via a wireless communication network, such as 3rd Generation (3G) or a Long Term Evolution (LTE). Further, the terminal apparatus 10 may include a screen, such as a liquid crystal display, with a function of a touch panel, and may receive various kinds of operation, such as tap operation, sliding operation, or scroll operation, on display data, such as contents, from a user by a finger, a stylus, or the like.

In the example illustrated in FIG. 2, the terminal apparatus 10 is used by a user U11. In the following, the terminal apparatus 10 may be described as the user U11. In other words, in the following, the user U11 may be read as the terminal apparatus 10.

The information processing apparatus 100 is an information processing apparatus for achieving improvement in services in accordance with a target body shape of the user, and is implemented by, for example, a server apparatus, a cloud system, or the like. For example, the information processing apparatus 100 has a function to provide information on a target body shape as a goal to be achieved by the user based on body shape information on the user and statistical data of body shape information that is based on attribute information on the user (for example, gender, an age, or a height). The information processing apparatus 100 is, for example, an information processing apparatus, such as a PC or a workstation (WS), and performs processes based on information that is transmitted from the management server 200 or the like via the network N.

The management server 200 is an information processing apparatus that manages an electronic mall, and is implemented by, for example, a server apparatus, a cloud system, or the like. For example, the management server 200 has a function to provide information (for example, an item, a size, or evaluation of a purchased product) on a purchase history of the user in the electronic mall. The management server 200 is, for example, an information processing apparatus, such as a PC or a WS, and performs processes based on information that is transmitted from the terminal apparatus 10 or the like via the network N.

Meanwhile, FIG. 1 illustrates a case in which the terminal apparatus 10, the information processing apparatus 100, and the management server 200 are separate apparatuses, but the terminal apparatus 10, the information processing apparatus 100, and the management server 200 may be integrated with one another. Further, arbitrary two of the terminal apparatus 10, the information processing apparatus 100, and the management server 200 may be integrated with each other.

### 2. One Example of Information Processing

In the embodiment below, for convenience of explanation, an example will be described in which clothes are adopted as an example of a target object that fits the target body shape of the user, but embodiments are not limited to this example. The target object is not limited to the clothes, but includes any object as long as the object is wearable by the user and a fit size of the object differs depending on the body shape of the user. For example, jewelry, such as a ring, may be adopted. Further, in the embodiment below, an example will be described in which a single registered account is associated with a single user in a predetermined electronic mall that is managed by the management server 200, but embodiments are not limited to this example. Meanwhile, a process in which a plurality of users are associated with a single registered account will be described later as a modification.

FIG. 2 is a diagram illustrating an example of information processing performed by the information processing system 1 according to one embodiment. In FIG. 2, it is assumed that a proposal is given to the user U11 via the terminal apparatus 10.

The information processing apparatus 100 acquires body shape information on a body shape of the user U11 (Step S101). Meanwhile, the information processing apparatus 100 may acquire the body shape information on the user U11 by any method. FIG. 2 illustrates a case in which the information processing apparatus 100 acquires the body shape information on the user U11 via clothes SU11 capable of measuring details of the body shape information by being worn, but embodiments are not limited to this example. For example, the information processing apparatus 100 may acquire the body shape information on the user U11 based on registration (input) performed by the user U11. Meanwhile, the body shape information acquired by the information processing apparatus 100 is not limited to information on a specific body size, such as an abdominal circumference, an arm circumference, or a thigh, but may include information on a height, a weight, or the like.

The information processing apparatus 100 acquires pieces of body shape information on a plurality of users based on attribute information on the user U11 (Step S102). For example, when the attribute information on the user U11 includes “gender: male, age: 30 to 35, height: 170 to 175 centimeters (cm)”, the information processing apparatus 100 acquires pieces of body shape information on a plurality of users including the same attribute information and performs statistical analysis. In this manner, the information processing apparatus 100 acquires statistical data of the body shape information based on the attribute information on the user U11. In FIG. 2, the information processing apparatus 100 acquires statistical data SD11. Meanwhile, FIG. 2 illustrates a case in which the pieces of body shape information on the plurality of users based on the attribute information on the user U11 are acquired from the management server 200, but embodiments are not limited to this example, and the pieces of body shape information may be acquired in any method. Further, if the pieces of body shape information on the plurality of users based on the attribute information on the user U11 are not acquired from the management server 200, the attribute information on the user U11 may be acquired from, for example, the management server 200. For example, the attribute information on the user U11 may be acquired from attribute data UD11. In this manner, the attribute information on the user U11 may be identified based on registration information that is registered by the user U11 on the predetermined electronic mall. Furthermore, the pieces of body shape information on the plurality of users based on the attribute information on the user U11 may be acquired from, for example, a storage unit of the information processing apparatus 100.

The statistical data SD11 will be described below. The statistical data SD11 is statistical data that is related to weights of users with the same attribute information of “gender: male, age: 30 to 35, height: 170 to 175 cm” as the user U11. A horizontal axis of the statistical data SD11 is an axis that represents a weight, and a vertical axis is an axis that represents the number of persons. For example, the statistical data SD11 indicates that the number of users with the weight of “61 to 70 kilograms (kg)” is six, which is maximum. Therefore, in the statistical data SD11, a user with the weight of “61 to 70 kg” is a user with the most standard body shape information with respect to the attribute information on the user U11. Meanwhile, in the following, a body shape of the user with the standard body shape information as described above will be appropriately referred to as a standard body shape based on the statistical data. The information processing apparatus 100 identifies a standard body shape ST11 based on the statistical data SD11. Meanwhile, for convenience of explanation, FIG. 2 illustrates a case in which the statistical data SD11 is statistical data related to weights, but embodiments are not limited to this example, and, for example, the statistical data may be related to a specific body size, such as an abdominal circumference, an arm circumference, or a thigh, or related to a total score that is obtained by scoring body shape information on each of the abdominal circumference, the arm circumference, the thigh, and the like and adding up the scores. Meanwhile, the statistical data SD11 is not limited to data based on a histogram as illustrated in FIG. 2, but may be any kind of statistical data.

The information processing apparatus 100 compares the body shape information on the user U11 and the body shape information on the standard body shape ST11, and calculates a difference between the body shape of the user U11 and the standard body shape ST11 (Step S103). For example, if the weight of the user U11 is 80 kg, the information processing apparatus 100 performs comparison with the standard body shape ST11 of “61 to 70 kg” and calculates a difference of 10 to 20 kg. The information processing apparatus 100 calculates that the body shape of the user U11 is a body shape that is heavier by about 10 to 20 kg than the standard body shape ST11 based on the difference. Accordingly, the user U11 is able to appropriately and statistically recognize a level of the body shape information on the user U11. Meanwhile, the information processing apparatus 100 may determine comparison with the standard body shape ST11 based on whether the difference is equal to or larger than a predetermined threshold. For example, if the weight of the user U11 is 72 kg and the predetermined threshold is 15 kg, the information processing apparatus 100 may determine that there is no difference from the standard body shape ST11.

The information processing apparatus 100 provides information on a target body shape as a goal to be achieved by the user U11 based on the difference from the standard body shape ST11 (Step S104). In FIG. 2, the information processing apparatus 100 adopts the standard body shape ST11 as a target body shape and provides information for proposing approach to the standard body shape ST11. Therefore, the information processing apparatus 100 is able to appropriately provide the body shape information as a goal with respect to the current body shape information on the user U11.

A screen UI11 is one example of a UI screen for proposing approach to the target body shape. The screen UI11 is displayed based on information that is provided by the information processing apparatus 100. In the screen UI11, a proposal of “this level of body shape is recommended based on your information” is displayed as one example of the information for proposing approach to the standard body shape ST11. Further, the screen UI11 includes a display item HK11 for displaying information on the standard body shape ST11. Conceptual information, such as “XXXXXXX AA1”, is displayed in the display item HK11 in FIG. 2, but in reality, specific information, such as “standard weight is 61 to 70 kg”, is displayed. Furthermore, it may be possible to display information on the difference from the body shape information on the user U11, such as “your weight is heavier by 10 kg, so let's lose 10 kg”, and display details are not specifically limited as long as the information related to the standard body shape ST11 is displayed. Moreover, the body shape information displayed on the display item HK11 is not limited to specific information represented by numerical values, but may be conceptual information, such as “let's lose some weight”, and display details are not specifically limited. With this configuration, the information processing apparatus 100 is able to promote health maintenance of the user U11 even from the viewpoint of healthcare.

The screen UI11 displays information on clothes that fit the current body shape of the user U11, together with the information for proposing approach to the standard body shape ST11. Specifically, the screen UI11 displays a proposal, such as “following clothes are recommended as clothes that fit your current body shape”, as one example of the information for proposing clothes that fit the current body shape of the user U11. Meanwhile, the clothes that are proposed in the screen UI11 are, for example, clothes that are available for purchase in the predetermined electronic mall that is managed by the management server 200.

The screen UI11 includes a display item HK12 for displaying information on the proposed clothes. The display item HK12 includes images PI11 to PI13. The images PI11 to PI13 are, for example, images of the clothes that are available for purchase in the predetermined electronic mall that is managed by the management server 200. The images PI11 to PI13 are, for example, images that are provided by the management server 200 that manages the predetermined electronic mall. Further, the images PI11 to PI13 are displayed in descending order of evaluation, best-sellers, or popularity, for example. Meanwhile, FIG. 2 illustrates a case in which the three images are displayed in the display item HK12 as one example of the images of the proposed clothes, but the number of images to be displayed is not specifically limited. Furthermore, the number of proposed clothes is not specifically limited. Moreover, the number of proposed clothes in the displayed images is not specifically limited, and it may be possible to propose coordination of clothes, for example. In other words, the images PI11 to PI13 are not limited to images of clothes, but may be coordination images.

Meanwhile, in the embodiment as described above, the case is illustrated in which the information processing apparatus 100 performs a process of displaying the information for proposing approach to the standard body shape ST11 that is the target body shape and the information on clothes that fit the current body shape of the user U11, but embodiments are not limited to this example. For example, the information processing apparatus 100 may perform a process of displaying information on clothes that fit the target body shape. Specifically, the information processing apparatus 100 may perform a process of displaying information on clothes that are available for purchase in the predetermined electronic mall managed by the management server 200 and that fit the target body shape. For example, when proposing clothes of “ooB” that are available for purchase in the predetermined electronic mall, the information processing apparatus 100 may perform a process of displaying a proposal of “celebrity ooA has worn clothes ooB, but your body shape is ooC, so how about losing weight?” With this configuration, the information processing apparatus 100 is able to clarify a worn image of the clothes that fit the target body shape, so that it is possible to promote increase in motivation in approaching the target body shape. Further, with this configuration, the information processing apparatus 100 is able to promote increase in motivation in approaching the target body shape, so that it is possible to promote increase in revenue and profit due to proposal of purchase of the clothes.

Meanwhile, in the embodiment as described above, the information processing apparatus 100 may provide information on clothes that fit the target body shape and that are highly evaluated. Specifically, the information processing apparatus 100 identifies a user who has purchased highly evaluated clothes based on a purchase history about a purchase that is performed in the predetermined electronic mall, and identifies a standard body shape based on the body shape information on the identified user. Further, the information processing apparatus 100 may associate the highly evaluated clothes and body shape information on the identified standard body shape in advance, and provide information on the highly evaluated clothes that fit the target body shape. Furthermore, the information processing apparatus 100 may provide information on highly evaluated clothes to a user who has set the target body shape on the user's side.

Meanwhile, in the embodiment as described above, if the user U11 sets the target body shape as a goal to be achieved as a response result with respect to the information displayed on the screen UI11, the information processing apparatus 100 may provide information for proposing approach to the set target body shape. This process will be described below.

Although not illustrated in the drawings, the information processing apparatus 100 may provide, for example, a UI that is able to generate a three-dimensional (3D) design of a target body shape to the user U11, and perform a process of enabling setting of the target body shape based on information on operation that is performed by the user U11 on the UI. Specifically, the information processing apparatus 100 may perform, on the screen UI11, a process of displaying a 3D design of a body shape based on the standard body shape ST11, and a process of enabling setting of the target body shape by, based on information on operation of modifying the 3D design by the user U11, quantifying a change amount of the modification.

The information processing apparatus 100 may make patterns of body shapes in advance, perform a process of displaying 3D designs of the plurality of patterned body shapes in the screen UI11, and perform a process of enabling setting of the target body shape based on a selection that is performed by the user U11 from among the plurality of designs. In this manner, the information processing apparatus 100 is able to allow the user to arbitrarily set the target body shape.

When the user sets the target body shape, the information processing apparatus 100 may perform a process of displaying information on clothes that fit the set target body shape in the same manner as in the case in which the target body shape is set by the system.

The information processing apparatus 100 may perform a process of enabling setting of the target body shape by setting clothes that the user U11 wants to wear. Specifically, if the user U11 selects clothes that the user wants to wear from among clothes that are available for purchase in the predetermined electronic mall that is managed by the management server 200, the information processing apparatus 100 may adopt a body shape that fits the selected clothes as a target body shape and provide information on the target body shape. Further, brands have different features such that, for example, arm parts of clothes are skinny. Therefore, for example, even when it is determined that the clothes will fit if the clothes do not have a certain feature such as skinny, in some cases, the user U11 need to lose weight if the user U11 wants to wear clothes of a certain brand with a certain feature such as skinny in consideration of a balance of the body shape. The information processing apparatus 100 may set clothes information, such as a brand, on clothes that the user U11 wants to wear, and perform a process of enabling setting of the target body shape while taking into account a feature based on an attribute, such as a brand, of clothes.

Meanwhile, in the embodiment as described above, the information processing apparatus 100 may provide information on the target body shape as a goal to be achieved by the user U11 while taking into account preference information on the user U11. For example, a slender body shape may be preferable for a user who likes running marathon, but a heavy body shape may be preferable for a user who likes doing martial arts. Therefore, the information processing apparatus 100 may change information on the target body shape to be provided based on the preference information on the user U11. For example, in the screen UI11, even when information of “standard weight is 61 to 70 kg” or “your weight is heavier by 10 kg, so let's lose 10 kg” is to be displayed if the preference information on the user U11 is not taken into account, the information processing apparatus 100 may perform a process of displaying information of “standard weight is 70 kg” or “your weight is heavier by 5 kg, so let's lose 5 kg”. This is based on estimation that a body shape that is heavy to some extent is preferable because the user U11 likes doing marital arts, for example. Further, as one example of the preference information, for example, if the user U11 likes clothes of a certain brand with a certain feature such as skinny, the information processing apparatus 100 may change the information on the target body shape to be provided based on clothes information on the brand. For example, brands have different features such that some parts are skinny or the like, and therefore, the information processing apparatus 100 may change the information on the target body shape to be provided based on the feature that is based on an attribute of the clothes in consideration of a balance of the body shape.

The information processing apparatus 100 may estimate the preference information on the user U11 based on evaluation on a purchased product by the user U11 for example, in order to take into account the preference information on the user U11. With this configuration, the information processing apparatus 100 is able to appropriately recognize preference for each clothes, that is, for example, preference for perfect fit, preference for loose fit, or preference for normal fit in case of sweatshirts. Meanwhile, the evaluation on the purchased product by the user U11 may be acquired by any kind of method, and, for example, may be acquired based on review that the user U11 has given for services provided by the predetermined electronic mall or based on a result of questionnaire given from the user U11. Further, the evaluation may be performed for each clothes or for each part of clothes (for example, waist is tight in case of trousers).

Meanwhile, in the embodiment as described above, the information processing apparatus 100 may provide the information on the target body shape as a goal to be achieved by the user U11 while taking into account stock information on the clothes that are available for purchase in the predetermined electronic mall that is managed by the management server 200. For example, when a stock quantity of a large size of certain clothes is equal to or larger than a predetermined threshold and if quantity of unsold stocks is larger than those of other sizes, the information processing apparatus 100 may perform a process of displaying information of “standard weight is 70 kg” or “your weight is heavier by 5 kg, so let's lose 5 kg” even when the information of “standard weight is 61 to 70 kg” or “your weight is heavier by 10 kg, so let's lose 10 kg” is to be displayed in the screen UI11 if the stock information is not taken into account. This is because, for example, the stock quantity of the large size is larger than stock quantity of a medium size. In this manner, the information processing apparatus 100 may change the information on the target body shape to be provided based on the stock information on the clothes that are available for purchase in the predetermined electronic mall. With this configuration, the information processing apparatus 100 is able to change the body shape of the user in accordance with the stock information on the predetermined electronic mall.

Meanwhile, in the embodiment as described above, the information processing apparatus 100 may perform a process of giving a privilege (for example, a point) that is available in the predetermined electronic mall when the user U11 approaches the target body shape that is a goal to be achieved. For example, the information processing apparatus 100 may give preferential treatment, such as increase in the privilege to be given, with approach to the target body shape. In this manner, the information processing apparatus 100 may provide information on the privilege that is increased with approach to the target body shape. Further, the information processing apparatus 100 may identify a degree to which the user U11 has approached the target body shape and provide information on the identified degree to the management server 200, and, the management server 200 may perform a process of giving a privilege. Furthermore, the information processing apparatus 100 may regularly or irregularly give preferential treatment, such as an increase in the privilege to be given, with respect to a user who has registered the body shape information. With this configuration, the information processing apparatus 100 is able to appropriately manage the body shape information on the user, so that it is possible to promote improvement in services in accordance with the user.

Meanwhile, in the embodiment as described above, the information processing apparatus 100 may dynamically change clothes or services to be provided in accordance with a change in the body shape or the purchase history of the user U11. For example, the information processing apparatus 100 may determine a change in the body shape or the purchase history of the user U11, and if it is determined that the change is equal to or larger than a predetermined threshold, it may be possible to dynamically change the target body shape in accordance with the change of the body shape or the purchase history of the user U11 and dynamically change clothes or services to be displayed on the screen UI11.

Meanwhile, in the embodiment as described above, the information processing apparatus 100 need not always be applied to services for proposing clothes that are available for purchase in an electronic mall, but may be applied to services for proposing other clothes, such as used clothes, for example.

### 3. Configuration of Terminal Apparatus

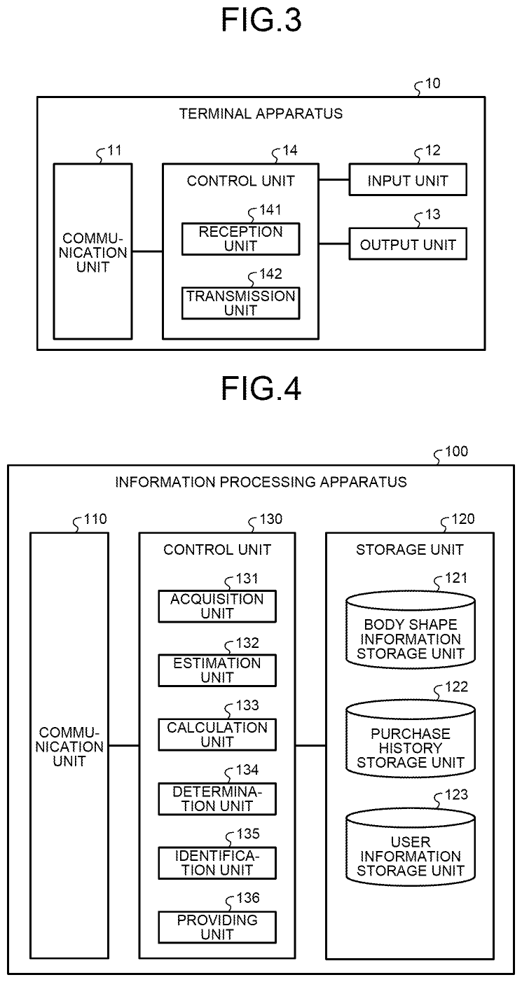

A configuration of the terminal apparatus 10 according to one embodiment will be described below with reference to FIG. 3. FIG. 3 is a diagram illustrating a configuration example of the terminal apparatus 10 according to one embodiment. As illustrated in FIG. 3, the terminal apparatus 10 includes a communication unit 11, an input unit 12, an output unit 13, and a control unit 14.

### Communication Unit 11

The communication unit 11 is implemented by, for example, a Network Interface Card (NIC) or the like. Further, the communication unit 11 is connected to the predetermined network N in a wired or wireless manner, and transmits and receives information to and from the information processing apparatus 100 or the like via the predetermined network N.

### Input Unit 12

The input unit 12 receives various kinds of operation from a user. In the example illustrated in FIG. 2, various kinds of operation from the user U11 are received. For example, the input unit 12 may receive various kinds of operation from the user via a display screen by a touch-panel function. Further, the input unit 12 may receive various kinds of operation from a button that is arranged in the terminal apparatus 10 or a keyboard or a mouse that is connected to the terminal apparatus 10.

### Output Unit 13

The output unit 13 is a display screen of a tablet terminal or the like that is implemented by, for example, a liquid crystal display, an organic Electro-Luminescence (EL) display, or the like, and is a display apparatus for displaying various kinds of information. For example, the output unit 13 displays information that is transmitted from the information processing apparatus 100.

### Control Unit 14

The control unit 14 is, for example, a controller, and is implemented by causing a Central Processing Unit (CPU), a Micro Processing Unit (MPU), or the like to execute various kinds of programs that are stored in an internal storage apparatus of the terminal apparatus 10 while using a Random Access Memory (RAM) as a work area. For example, the various kinds of programs include a program of an application that is installed in the terminal apparatus 10. For example, the various kinds of programs include a program of an application that displays information transmitted from the information processing apparatus 100. Further, the control unit 14 is implemented by, for example, an integrated circuit, such as an Application Specific Integrated Circuit (ASIC) or a Field Programmable Gate Array (FPGA).

As illustrated in FIG. 3, the control unit 14 includes a reception unit 141 and a transmission unit 142, and implements or executes operation of information processing as described below.

### Reception Unit 141

The reception unit 141 receives various kinds of information. The reception unit 141 receives various kinds of information from an external information processing apparatus. The reception unit 141 receives various kinds of information from a different information processing apparatus, such as the information processing apparatus 100. For example, the reception unit 141 receives the information for proposing approach to the target body shape.

### Transmission Unit 142

The transmission unit 142 transmits various kinds of information to an external information processing apparatus. The transmission unit 142 transmits various kinds of information to a different information processing apparatus, such as the information processing apparatus 100. For example, the transmission unit 142 transmits the body shape information that is input by the user.

### 4. Configuration of Information Processing Apparatus

A configuration of the information processing apparatus 100 according to one embodiment will be described below with reference to FIG. 4. FIG. 4 is a diagram illustrating a configuration example of the information processing apparatus 100 according to one embodiment. As illustrated in FIG. 4, the information processing apparatus 100 includes a communication unit 110, a storage unit 120, and a control unit 130. Meanwhile, the information processing apparatus 100 may include an input unit (for example, a keyboard, a mouse, or the like) that receives various kinds of operation from an administrator of the information processing apparatus 100, or a display unit (for example, a liquid crystal display or the like) for displaying various kinds of information.

### Communication Unit 110

The communication unit 110 is implemented by, for example, a NIC or the like. Further, the communication unit 110 is connected to the network N in a wired or wireless manner, and transmits and receives information to and from the terminal apparatus 10 or the like via the network N.

### Storage Unit 120

The storage unit 120 is implemented by, for example, a semiconductor memory device, such as a RAM or a flash memory, or a storage device, such as a hard disk or an optical disk. As illustrated in FIG. 4, the storage unit 120 includes a body shape information storage unit 121, a purchase history storage unit 122, and a user information storage unit 123.

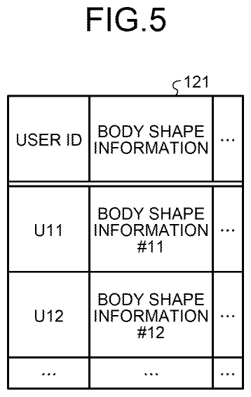

The body shape information storage unit 121 stores therein the body shape information on the user. Here, FIG. 5 illustrates an example of the body shape information storage unit 121 according to one embodiment. As illustrated in FIG. 5, the body shape information storage unit 121 includes items, such as a “user ID” and “body shape information”.

The “user ID” indicates identification information for identifying a user. The “body shape information” indicates the body shape information. In the example illustrated in FIG. 5, an example is illustrated in which conceptual information, such as “body shape information #11” or “body shape information #12”, is stored in the “body shape information”, but in reality, a measurement value of an abdominal circumference, an arm circumference, or a thigh is stored.

Specifically, FIG. 5 illustrates an example in which the body shape information on the user who is identified by a user ID of “U11” is the “body shape information #11”.

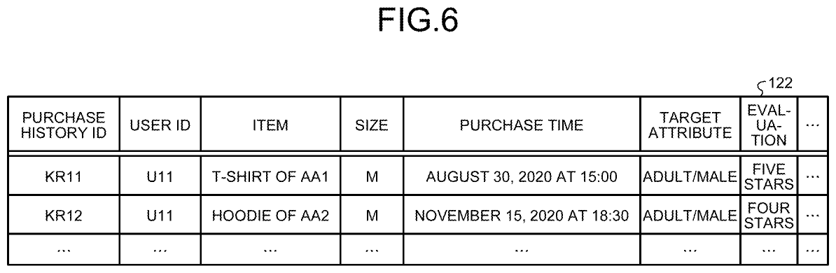

The purchase history storage unit 122 stores therein information on the purchase history of the user. For example, the purchase history storage unit 122 stores therein information on a purchase history about a purchase performed in a predetermined electronic mall that is managed by the management server 200. Here, FIG. 6 illustrates an example of the purchase history storage unit 122 according to one embodiment. As illustrated in FIG. 6, the purchase history storage unit 122 includes items, such as a “purchase history ID”, a “user ID”, an “item”, a “size”, a “purchase time”, a “target attribute”, and “evaluation”.

The “purchase history ID” indicates identification information for identifying a purchase history. The “user ID” indicates identification information for identifying a user. The “item” indicates an item of a purchased product. The “size” indicates a size of the purchased product. The “purchase time” indicates a time when the purchased product is purchased. The “target attribute” indicates an attribute of a target user of the purchased product. The “evaluation” indicates evaluation on the purchased product. Meanwhile, the “evaluation” may be evaluation performed by the user who is identified by the “user ID”, or average evaluation performed by users who have purchased the purchased product.

Specifically, FIG. 6 illustrates an example in which a user who has performed a purchase that is identified by a purchase history ID of “KR11” is identified by “U11”, an item of the purchased product is a “T-shirt of AA1”, a size is “M”, a purchase time is “Aug. 30, 2020 at 15:00”, a target attribute is “adult male”, and evaluation is “five stars”.

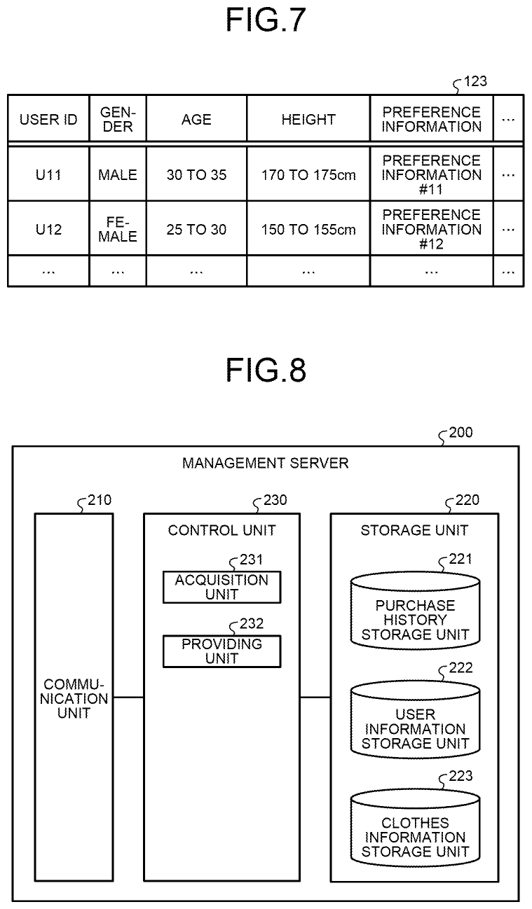

The user information storage unit 123 stores therein user information. For example, the user information storage unit 123 stores therein the attribute information on the user. Here, FIG. 7 illustrates an example of the user information storage unit 123 according to one embodiment. As illustrated in FIG. 7, the user information storage unit 123 includes items, such as a “user ID”, “gender”, an “age”, a “height”, and “preference information”.

The “user ID” indicates identification information for identifying a user. The “gender” indicates gender of the user. The “age” indicates an age of the user. The “height” indicates a height of the user. The “preference information” indicates preference information on the user. In the example illustrated in FIG. 7, an example is illustrated in which conceptual information, such as “preference information #11” and “preference information #12”, is stored in the “preference information”, but in reality, specific information, such as marathon, preference to clothe of slender brands, or preference to tight fit sweatshirts, is stored.

Specifically, FIG. 7 illustrates an example in which a user who is identified by a user ID of “U11” is a user with gender of “male”, an age of “30 to 35 years old”, a height of “170 to 175 cm”, and preference information of “preference information #11”.

### Control Unit 130

The control unit 130 is a controller and is implemented by, for example, causing a CPU, an MPU, or the like to execute various kinds of programs that are stored in an internal storage apparatus of the information processing apparatus 100 while using a RAM as a work area. Further, the control unit 130 is a controller and is implemented by, for example, an integrated circuit, such as an ASIC or an FPGA.

As illustrated in FIG. 4, the control unit 130 includes an acquisition unit 131, an estimation unit 132, a calculation unit 133, a determination unit 134, an identification unit 135, and a providing unit 136, and implements or executes operation of information processing as described below. Meanwhile, an internal configuration of the control unit 130 is not limited to the configuration as illustrated in FIG. 4, and any configuration is applicable as long as the information processing to be described later is performed.

### Acquisition Unit 131

The acquisition unit 131 acquires various kinds of information. The acquisition unit 131 acquires various kinds of information from an external information processing apparatus. The acquisition unit 131 acquires various kinds of information from a different information processing apparatus, such as the management server 200.

The acquisition unit 131 acquires various kinds of information from the storage unit 120. The acquisition unit 131 acquires various kinds of information from the body shape information storage unit 121, the purchase history storage unit 122, or the user information storage unit 123. Further, the acquisition unit 131 stores various kinds of acquired information in the storage unit 120. The acquisition unit 131 stores various kinds of information in the body shape information storage unit 121, the purchase history storage unit 122, or the user information storage unit 123.

The acquisition unit 131 acquires the body shape information on the user. For example, the acquisition unit 131 acquires the body shape information that is measured by a body shape information measurement means that is able to measure details of the body shape information by being worn.

The acquisition unit 131 acquires information on the purchase history of the user. For example, the acquisition unit 131 acquires information on a purchase history about a purchase that is performed in the predetermined electronic mall.

The acquisition unit 131 acquires user information on a user. For example, the acquisition unit 131 acquires attribute information that is registered in the predetermined electronic mall or evaluation information on a purchased product.

The acquisition unit 131, when a plurality of users are associated with a single account, acquires the body shape information or the user information for each of the users who are associated with the single account. Further, the acquisition unit 131 acquires information on purchase histories for the plurality of users who are associated with the single account. In other words, the acquisition unit 131 acquires information on the purchase history of a purchase performed by one of the users, for each of the users.

### Estimation Unit 132

The estimation unit 132 estimates preference information on the user. For example, the estimation unit 132 estimates the preference information on the user based on the information on the evaluation on the purchased product by the user. Further, for example, the estimation unit 132 may estimate clothes that the user considers a purchase in the predetermined electronic mall, based on predetermined information, such as operation information, browsing information, or search information, on the user.

The estimation unit 132 estimates a change of the body shape of the user. For example, the estimation unit 132 estimates a change of the body shape of the user based on the information on the purchase history.

The estimation unit 132, when a plurality of users are associated with a single account, may estimate attribute information for each of the users. Further, the estimation unit 132 may estimate a relationship, such as a family structure, of the plurality of users based on the estimation result.

### Calculation Unit 133

The calculation unit 133 calculates a difference between the body shape of the user and the standard body shape based on the body shape information on the user and the statistical data of the body shape information that is based on the attribute information on the user. For example, if the weight of the user is 80 kg and the weight of the standard body shape is 70 kg, the calculation unit 133 calculates that a difference is 10 kg.

### Determination Unit 134

The determination unit 134 determines a change of the body shape or the purchase history of the user. Further, the determination unit 134 determines that the target body shape is to be changed based on the determination result. For example, the determination unit 134 determines that the target body shape is dynamically changed in accordance with a change of the body shape or the purchase history of the user.

The determination unit 134 compares the body shape information on the user and the body shape information on the standard body shape, and determines whether a difference is equal to or larger than a predetermined threshold. Further, if it is determined that the difference is equal to or larger than the predetermined threshold, the determination unit 134 determines that a proposal for approach to the target body shape is to be given.

The determination unit 134 may determine whether a plurality of users are associated with a single account. Further, if the plurality of users are associated with a single account, the determination unit 134 may determine a change of the body shape or the purchase history for each of the users.

### Identification Unit 135

The identification unit 135 identifies clothes or services that will fit. For example, the identification unit 135 identifies clothes or services that fit the current body shape of the user. Further, for example, the identification unit 135 identifies clothes or services that fit the target body shape.

The identification unit 135 identifies a user who has purchased highly evaluated clothes based on the purchase history about a purchase performed in the predetermined electronic mall. Further, the identification unit 135 identifies a standard body shape based on the body shape information on the identified user.

The identification unit 135, when a plurality of users are associated with a single account, may identify a user who is to be subjected to determination performed by the determination unit 134 among the plurality of users, based on an attribute of the purchased product included in the purchase history associated with the single account.

### Providing Unit 136

The providing unit 136 provides information on a target body shape that corresponds to the difference calculated by the calculation unit 133. For example, the providing unit 136 provides information for proposing approach to the target body shape.

### 5. Configuration of Management Server

A configuration of the management server 200 according to one embodiment will be described below with reference to FIG. 8. FIG. 8 is a diagram illustrating a configuration example of the management server 200 according to one embodiment. As illustrated in FIG. 8, the management server 200 includes a communication unit 210, a storage unit 220, and a control unit 230. Meanwhile, the management server 200 may include an input unit (for example, a keyboard, a mouse, or the like) that receives various kinds of operation from an administrator of the management server 200, or a display unit (for example, a liquid crystal display or the like) for displaying various kinds of information.

### Communication Unit 210

The communication unit 210 is implemented by, for example, a NIC or the like. Further, the communication unit 210 is connected to the network N in a wired or wireless manner, and transmits and receives information to and from the information processing apparatus 100 or the like via the network N.

### Storage Unit 220

The storage unit 220 is implemented by, for example, a semiconductor memory device, such as a RAM or a flash memory, or a storage device, such as a hard disk or an optical disk. As illustrated in FIG. 8, the storage unit 120 includes a purchase history storage unit 221, a user information storage unit 222, and a clothes information storage unit 223.

The purchase history storage unit 221 stores therein the same information as the purchase history storage unit 122. Therefore, detailed explanation will be omitted.

The user information storage unit 222 stores therein the same information as the user information storage unit 123. Therefore, detailed explanation will be omitted.

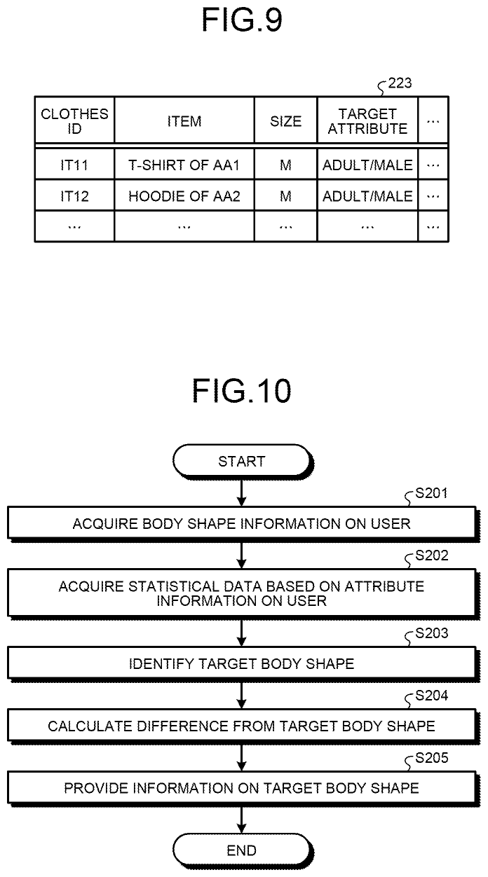

The clothes information storage unit 223 stores therein clothes information. For example, the clothes information storage unit 223 stores therein information on clothes that are available for purchase in the predetermined electronic mall that is managed by the management server 200. Here, FIG. 9 illustrates an example of the clothes information storage unit 223 according to one embodiment. As illustrated in FIG. 9, the clothes information storage unit 223 includes items, such as a “clothes ID”, an “item”, a “size”, and a “target attribute”.

The “clothes ID” indicates identification information for identifying clothes. The “item” indicates an item of the clothes. The “size” indicates a size of the clothes. The “target attribute” indicates an attribute of a target user of the clothes.

Specifically, FIG. 9 illustrates a case in which an item of clothes identified by a clothes ID of “IT11” is a “T-shirt of AA1”, a size is “M”, and a target attribute is “adult male”.

### Control Unit 230

The control unit 230 is a controller and is implemented by, for example, causing a CPU, an MPU, or the like to execute various kinds of programs that are stored in an internal storage apparatus of the management server 200 while using a RAM as a work area. Further, the control unit 230 is a controller and is implemented by, for example, an integrated circuit, such as an ASIC or an FPGA.

As illustrated in FIG. 9, the control unit 230 includes an acquisition unit 231 and a providing unit 232, and implements or executes operation of information processing as described below. Meanwhile, an internal configuration of the control unit 230 is not limited to the configuration as illustrated in FIG. 9, and any configuration is applicable as long as the information processing to be described later is performed.

### Acquisition Unit 231

The acquisition unit 231 acquires information on the purchase history of the user. Further, the acquisition unit 231 acquires the user information. Furthermore, the acquisition unit 131 acquires the clothes information.

### Providing Unit 232

The providing unit 232 provides the information on the purchase history of the user. Further, the providing unit 232 provides the user information. Furthermore, the providing unit 232 provides the clothes information.

### 6. Flow of Information Processing

The flow of information processing performed by the information processing system 1 according to one embodiment will be described below with reference to FIG. 10. FIG. 10 is a flowchart illustrating the flow of the information processing performed by the information processing system 1 according to one embodiment.

As illustrated in FIG. 10, the information processing apparatus 100 acquires the body shape information on the user (Step S201).

The information processing apparatus 100 acquires the statistical data of the body shape information based on the attribute information on the user (Step S202).

The information processing apparatus 100 identifies a target body shape based on the acquired statistical data (Step S203).

The information processing apparatus 100 calculates a difference from the identified target body shape based on the acquired body shape information on the user (Step S204).

The information processing apparatus 100 provides information on the target body shape in accordance with the calculated difference (Step S205).

### 7. Modification

The information processing system 1 according to one embodiment as described above may be embodied in various different forms other than the embodiment as described above. Therefore, other embodiments of the information processing system 1 will be described below.

Case in which Plurality of Users are Associated with Single Account

In the embodiment as described above, the example has been explained in which a single user is associated with a single registered account in the predetermined electronic mall that is managed by the management server 200, but embodiments are not limited to this example. Specifically, in the embodiment as described above, a plurality of users may be associated with a single registered account. For example, when the user has a family, there may be a case in which the user purchases clothes for the family (for example, a child of the user or the like). A process that is performed when a plurality of users are associated with a single registered account in the predetermined electronic mall that is managed by the management server 200 will be described below. Meanwhile, the same explanation as FIG. 2 will be appropriately omitted.

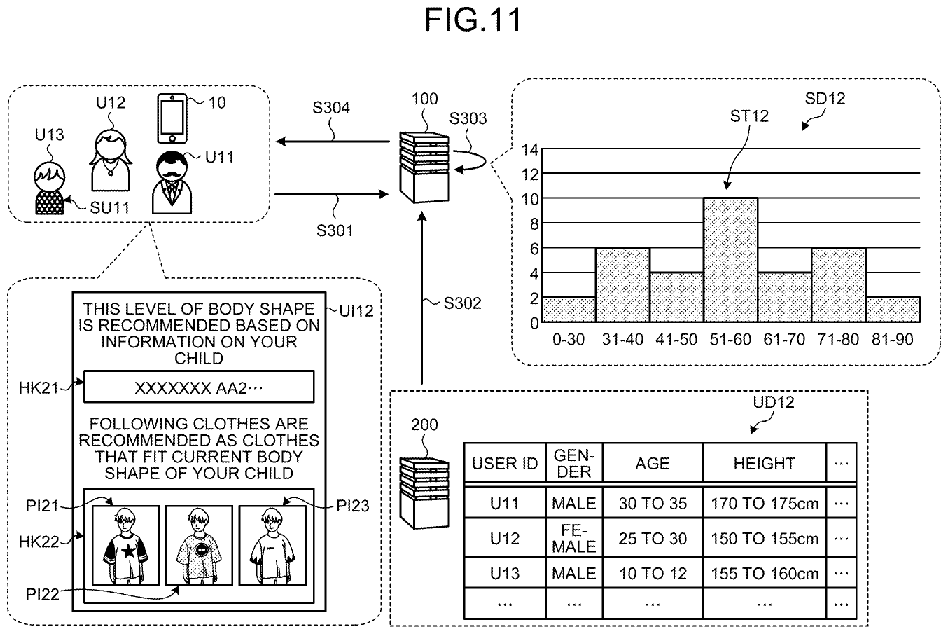

In FIG. 11, it is assumed that a proposal is given to the user U1 via the terminal apparatus 10, but explanation will be given based on the assumption that the user U11 who has an account has a family FA11 consisting of a user U12 and a user U13, and the user U12 and the user U13 are also associated with the account of the user U11. In the following, explanation will be given based on the assumption that the user U12 is a spouse of the user U11 and the user U13 is a child of the user U11. Meanwhile, in the following, for convenience of explanation, a case will be described in which three users are associated with a single account, but embodiments are not limited to this example, and the number of a plurality of users is not specifically limited. Meanwhile, in the following, a case will be described in which the user U13 wears clothes SU11 and body shape information on the user U13 will be measured.

The information processing apparatus 100 acquires body shape information on the user U13 among the plurality of users associated with the single account (Step S301). Meanwhile, the information processing apparatus 100 may identify the user who is wearing the clothes SU11 based on input performed by the user U11 or based on a measurement result that is obtained by measurement by the clothes SU11 and pieces of user information on the users included in the family FA11, for example. For example, if the measurement result indicates the body shape information on a child size, the information processing apparatus 100 identifies the user who is wearing the clothes SU11 among users with attributes indicating children.

The information processing apparatus 100 acquires pieces of body shape information on the plurality of users based on the attribute information on the user U13 (Step S302). Meanwhile, the attribute information on the user U13 may be identified by registration information that is registered by the user U11 on the predetermined electronic mall. For example, the attribute information on the user U13 may be identified by attribute data UD12.

The information processing apparatus 100 identifies a standard body shape ST12 based on statistical data SD12.

The information processing apparatus 100 compares the body shape information on the user U13 and the body shape information on the standard body shape ST12, and calculates a difference between the body shape of the user U13 and the standard body shape ST12 (Step S303).

The information processing apparatus 100 provides information on a target body shape as a goal to be achieved by the user U13 in accordance with the difference from the standard body shape ST12 (Step S304). In FIG. 11, the information processing apparatus 100 adopts the standard body shape ST12 as a target body shape and provides information for proposing approach to the standard body shape ST12.

A screen UI12 is one example of a UI screen for proposing approach to the target body shape. The screen UI12 is displayed based on information that is provided by the information processing apparatus 100. In the screen UI12, a proposal of “this level of body shape is recommended based on information on your child” is displayed as one example of the information for proposing approach to the standard body shape ST12. Further, the screen UI12 includes a display item HK21 for displaying information on the standard body shape ST12. Conceptual information, such as “XXXXXXX AA2”, is displayed in the display item HK21 in FIG. 11, but in reality, specific information, such as “standard weight is 51 to 60 kg for information on your child”, is displayed.

The screen UI12 displays information on clothes that fit the current body shape of the user U13, together with the information for proposing approach to the standard body shape ST12. Specifically, the screen UI12 displays a proposal, such as “following clothes are recommended as clothes that fit current body shape of your child”, as one example of the information for proposing clothes that fit to the current body shape of the user U13. Meanwhile, the clothes that are proposed in the screen UI12 are, for example, clothes that are available for purchase in the predetermined electronic mall that is managed by the management server 200. Meanwhile, the screen UI12 need not always display clothes that fit the current body shape of the user U13, but may display information on clothes that fit the target body shape.

The screen UI12 includes a display item HK22 for displaying information on the proposed clothes. The display item HK22 includes images PI21 to PI23. The images PI21 to PI23 are, for example, images of children's clothes that are available for purchase in the predetermined electronic mall that is managed by the management server 200. The images PI21 to PI23 are images that are provided by the management server 200 that manages the predetermined electronic mall, for example.

Meanwhile, in the modification as described above, for convenience of explanation, the case has been described in which the family FA11 of the user U11 has a single child, but there may be a case in which a family has a plurality of children. For example, there may be a case in which the family has two or more children close in age and of the same gender. In this case, the identification unit 135 may identify a target user for whom the target body shape is to be proposed or a target user for whom a change of the body shape is to be determined, based on, for example, information that is received in advance from the user U11 (for example, registration information).

Meanwhile, in the modification as described above, the plurality of users may be associated with the single account based on the information that is received from the user U11, but embodiments are not limited to this example. For example, the estimation unit 132 may estimate a family structure of the user U11 based on information on the purchased product included in the purchase history, estimate attribute information on a plurality of estimated users, and associate the plurality of estimated users. Specifically, if the user U11 has purchased three kinds of clothes with different target attributes, the estimation unit 132 may estimate that the family of the user U11 consists of three persons, estimate attribute information on the estimated three persons based on the respective target attributes, and associate the three estimated users and the three kinds of clothes.

### 8. Effects

As described above, the information processing apparatus 100 according to one embodiment includes the acquisition unit 131, the calculation unit 133, and the providing unit 136. The acquisition unit 131 acquires body shape information on a body shape of a user. The calculation unit 133 calculates, based on comparison between the body shape information on the user acquired by the acquisition unit 131 and statistical data of body shape information that is based on attribute information on the user, a difference from a standard body shape that is based on the statistical data. The providing unit 136 provides information on a target body shape as a goal to be achieved by the user in accordance with the difference that is calculated by the calculation unit 133.

With this configuration, the information processing apparatus 100 according to one embodiment is able to clarify the difference between the body shape of the user and the target body shape and appropriately give a proposal for approach to the target body shape, so that it is possible to promote improvement in services in accordance with the user.

Further, the calculation unit 133 calculates the difference based on statistical data of body shape information that is provided by a server that manages a predetermined electronic mall. Furthermore, the providing unit 136 provides information on a target object that is available for purchase in the predetermined electronic mall and that fits the body shape of the user.

With this configuration, the information processing apparatus 100 according to one embodiment is able to appropriately manage the body shape information on the user by the server, so that it is possible to promote improvement in services in accordance with the user.

Moreover, the acquisition unit 131 acquires body shape information on a user with a standard body shape among users who have purchased target objects that are highly evaluated, based on a purchase history about purchases performed in the predetermined electronic mall. Furthermore, the providing unit 136 provides information on a target object that fits the standard body shape and that is highly evaluated, based on association with the body shape information on the standard body shape.

With this configuration, the information processing apparatus 100 according to one embodiment is able to appropriately propose a highly evaluated target object, so that it is possible to promote improvement in services in accordance with the user.

Moreover, the providing unit 136 provides information on a target object that fits the target body shape, together with the information for proposing approach to the target body shape from the body shape of the user.

With this configuration, the information processing apparatus 100 according to one embodiment is able to clarify a worn image of the clothes that fit the target body shape, so that it is possible to promote improvement in motivation for approach to the target body shape.

Furthermore, the providing unit 136, if the user sets a target body shape as a goal as a response result with respect to the provided information on the target body shape, provides information on a target object that fits the set target body shape.

With this configuration, the information processing apparatus 100 according to one embodiment is able to allow the user to arbitrarily set the target body shape.

Moreover, the providing unit 136, if the user sets a target object that the user wants to wear as a response result with respect to the provided information on the target body shape, adopts a body shape that fits the set target object as a target body shape as a goal to be achieved by the user and provides information on the target body shape.

With this configuration, the information processing apparatus 100 according to one embodiment is able to allow the user to easily set the target body shape, and it is possible to further promote improvement in usability.

Furthermore, the providing unit 136 provides information on a privilege that is available in the predetermined electronic mall and that is increased as the user approaches the target body shape as a goal.

With this configuration, the information processing apparatus 100 is able to promote improvement in motivation in approaching the target body shape.

### 9. Hardware Configuration

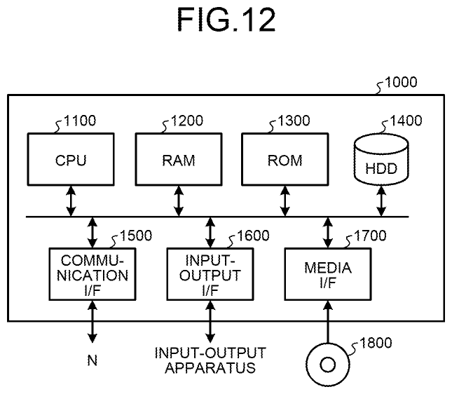

The terminal apparatus 10, the information processing apparatus 100, and the management server 200 according to one embodiment as described above are implemented by, for example, a computer 1000 as illustrated in FIG. 12. FIG. 12 is a hardware configuration diagram illustrating an example of the computer that implements the functions of the terminal apparatus 10, the information processing apparatus 100, and the management server 200. The computer 1000 includes a CPU 1100, a RAM 1200, a ROM 1300, an HDD 1400, a communication interface (I/F) 1500, an input-output interface (I/F) 1600, and a media interface (I/F) 1700.

The CPU 1100 operates based on a program that is stored in the ROM 1300 or the HDD 1400 and controls each of the units. The ROM 1300 stores therein a boot program that is executed by the CPU 1100 when the computer 1000 is activated, a program that is dependent on hardware of the computer 1000, or the like.

The HDD 1400 stores therein the program that is executed by the CPU 1100, data that is used by the program, and the like. The communication interface 1500 receives data from a different apparatus via a predetermined communication network, sends the data to the CPU 1100, and transmits data generated by the CPU 1100 to a different apparatus via the predetermined communication network.

The CPU 1100 controls an output apparatus, such as a display or a printer, and an input apparatus, such as a keyboard or a mouse, via the input-output interface 1600. The CPU 1100 acquires data from the input apparatus via the input-output interface 1600. Further, the CPU 1100 outputs generated data to the output apparatus via the input-output interface 1600.

The media interface 1700 reads the program or the data that is stored in a recording medium 1800, and provides the program or the data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium, such as a Digital Versatile Disc (DVD) or a phase change rewritable Disk (PD), a magneto optical recording medium, such as a Magneto-Optical disk (MO), a tape medium, a magnetic recording medium, a semiconductor memory, or the like.

For example, when the computer 1000 functions as the terminal apparatus 10, the information processing apparatus 100, and the management server 200 according to one embodiment, the CPU 1100 of the computer 1000 executes programs that are loaded on the RAM 1200 and implements the functions of the control units 14, 130, and 230. The CPU 1100 of the computer 1000 reads the programs from the recording medium 1800 and executes the programs; however, as another example, it may be possible to acquire the programs from a different apparatus via a predetermined communication network.

### 10. Others

Of the processes described in the embodiments, all or part of a process described as being performed automatically may also be performed manually.

Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments as described above may be combined appropriately as long as no contradiction is derived in the processing contents.

While some embodiments of the present application have been described in detail above based on the drawings, the embodiments are described by way of example, and the present invention may be embodied in various other forms with various changes or modifications based on knowledge of a person skilled in the art, in addition to the embodiments described in “Description of Embodiments”.

In addition, “a section, a module, or a unit” described above may be replaced with “a means” or “a circuit”. For example, the acquisition unit may be replaced with an acquisition means or an acquisition circuit.

### REFERENCE SIGNS LIST

1 information processing system
10 terminal apparatus
11 communication unit
12 input unit
13 output unit
14 control unit
100 information processing apparatus
110 communication unit
120 storage unit
121 body shape information storage unit
122 purchase history storage unit
123 user information storage unit
130 control unit
131 acquisition unit
132 estimation unit
133 calculation unit
134 determination unit
135 identification unit
136 providing unit
141 reception unit
142 transmission unit
200 management server
210 communication unit
220 storage unit
221 purchase history storage unit
222 user information storage unit
223 clothes information storage unit
230 control unit
231 acquisition unit
232 providing unit
N network

1. An information processing apparatus including a processor configured to:
acquire body shape information on a body shape of a user;
calculate, based on comparison between the acquired body shape information and statistical data of body shape information that is based on attribute information on the user, a difference from a standard body shape that is based on the statistical data; and
provide the user with information on a target body shape as a goal to be achieved by the user in accordance with the difference that is calculated by the calculation unit.

2. The information processing apparatus according to claim 1, wherein the processor is further configured to:
calculate the difference based on statistical data of body shape information that is provided by a server that manages a predetermined electronic mall, and
provide the user with information on a target object that is available for purchase in the predetermined electronic mall and that fits the body shape of the user.

3. The information processing apparatus according to claim 1, wherein the processor is further configured to:
acquire the body shape information on a user with a standard body shape among users who have purchased target objects that are highly evaluated, based on a purchase history about purchases performed in the predetermined electronic mall, and
provide the user with information on a target object that fits the standard body shape and that is highly evaluated, based on association with the body shape information on the standard body shape.

4. The information processing apparatus according to claim 1, wherein the processor is further configured to provide the user with information on a target object that fits the target body shape, together with the information for proposing approach to the target body shape from the body shape of the user.

5. The information processing apparatus according to claim 1, wherein, in response to the user setting a target body shape as a goal as a response result with respect to the provided information on the target body shape, the processor is further configured to provide the user with information on a target object that fits the set target body shape.

6. The information processing apparatus according to claim 5, wherein, in response to the user setting a target object that the user wants to wear as a response result with respect to the provided information on the target body shape, the processor is further configured to adopt a body shape that fits the set target object as a target body shape as a goal to be achieved by the user and provide the user with information on the target body shape.

7. The information processing apparatus according to claim 5, wherein the processor is further configured to provide the user with information on a privilege that is available in the predetermined electronic mall and that is increased as the user approaches the target body shape as a goal.

8. An information processing method implemented by a computer, the information processing method including:
acquiring body shape information on a body shape of a user;
calculating, based on comparison between the acquired body shape information and statistical data of body shape information that is based on attribute information on the user, a difference from a standard body shape that is based on the statistical data; and
providing information on a target body shape as a goal to be achieved by the user in accordance with the difference calculated.

9. A non-transitory tangible machine-readable medium having an information processing program that, when executed by a computer, causes the computer to:
acquire body shape information on a body shape of a user;
calculate, based on comparison between the acquired body shape information and statistical data of body shape information that is based on attribute information on the user, a difference from a standard body shape that is based on the statistical data; and
provide information on a target body shape as a goal to be achieved by the user in accordance with the difference calculated.
